(19) United States
(12) Patent Application Publication
(10) Pub. No.: US 2015/0073752 A1
(43) Pub. Date: Mar. 12, 2015

(54) WAVEFRONT MEASURING APPARATUS, WAVEFRONT MEASURING METHOD, METHOD OF MANUFACTURING OPTICAL ELEMENT, AND ASSEMBLY ADJUSTMENT APPARATUS OF OPTICAL SYSTEM

(71) Applicant: CANON KABUSHIKI KAISHA, Tokyo (JP)

(72) Inventors: Akinori OHKUBO, Hidaka-shi (JP); Yuki YONETANI, Utsunomiya-shi (JP)

(21) Appl. No.: 14/464,780

(22) Filed: Aug. 21, 2014

(30) Foreign Application Priority Data
Sep. 11, 2013 (JP) 2013-188814

(51) Int. Cl. G01J 9/02; G01J 9/00

(52) U.S. Cl. CPC G01J 9/02; G01J 9/00
USPC 702/189

(57) ABSTRACT

A wavefront measuring apparatus configured to measure a transmitted wavefront or reflected wavefront of an optical element includes a measuring unit configured to measure a light intensity distribution based on a light beam transmitted through or reflected by the optical element, a region determining unit configured to determine a first region and a second region based on a plurality of spot positions in the light intensity distribution, a first signal processor configured to calculate a first wavefront by using a linear model based on information of the light intensity distribution of the first region, and a second signal processor configured to estimate a second wavefront by repeating a light propagation calculation with the first wavefront as an initial value based on information of the light intensity distributions of the first region and the second region.

### BACKGROUND OF THE INVENTION

1. Field of the Invention

The present invention relates to a wavefront measuring apparatus for measuring a transmitted wavefront or reflected wavefront of an optical element.

2. Description of the Related Art

An imaging optical system includes an optical element such as a mirror or a lens, and an optical unit as a combination thereof. Measuring the transmitted wavefront or reflected wavefront (test wavefront) of each optical element or each optical unit before assembling the imaging optical system ensures the performance of the optical element or the optical unit. Daniel Malacara, “Optical Shop Testing”, Third Edition, Wiley-Interscience, pp. 383-386 discloses a Shack-Hartmann wavefront sensor (SHWFS) for measuring the transmitted wavefront (test wavefront).

However, a large displacement of the test wavefront makes it difficult or impossible to reconstruct the test wavefront with the SHWFS. To solve this problem, Eric P. Goodwin and James C. Wyant, “Field Guide to Interferometric Optical Testing (Spie Field Guides)”, SPIE Press, p. 79 discloses a method using a compensator that corrects the displacement of the test wavefront to be within a dynamic range measurable by a wavefront measuring sensor. This makes it possible to deal with a case of a large displacement of the test wavefront.

However, as disclosed in Eric P. Goodwin and James C. Wyant, “Field Guide to Interferometric Optical Testing (Spie Field Guides)”, SPIE Press, p. 79, correcting the displacement of the test wavefront with the compensator to be within the dynamic range of the wavefront measuring sensor adversely increases measurement inaccuracy due to an arrangement error and an shape error of the compensator. In addition, the compensator needs to be highly accurately designed and manufactured, which takes time and cost in preparing the compensator. Furthermore, since each test optical system as a measurement target requires a corresponding compensator, an increase in the type of the test optical system leads to an increase in the type of the compensator and thus an increase in wavefront measuring cost.

### SUMMARY OF THE INVENTION

The present invention provides a wavefront measuring apparatus and a wavefront measuring method that are capable of performing a highly accurate low-cost measurement of the wavefront of an optical element having a large wavefront aberration, a method of manufacturing the optical element, and assembly adjustment apparatus of the optical system.

A wavefront measuring apparatus as one aspect of the present invention is a wavefront measuring apparatus configured to measure a transmitted wavefront or reflected wavefront of an optical element and includes a measuring unit configured to measure a light intensity distribution based on a light beam transmitted through or reflected by the optical element, a region determining unit configured to determine a first region and a second region based on a plurality of spot positions in a light intensity distribution, a first signal processor configured to calculate a first wavefront by using a linear model based on information of a light intensity distribution of the first region, and a second signal processor configured to estimate a second wavefront by repeating a light propagation calculation with the first wavefront as an initial value based on information of the light intensity distributions of the first region and the second region.

A wavefront measuring method as another aspect of the present invention is a wavefront measuring method configured to measure a transmitted wavefront or reflected wavefront of an optical element, and the method including the steps of measuring a light intensity distribution based on light beam transmitted through or reflected by the optical element, determining a first region and a second region based on a plurality of spot positions in a light intensity distribution, calculating a first wavefront by using a linear model based on information of a light intensity distribution of the first region, and estimating a second wavefront by repeating a light propagation calculation with the first wavefront as an initial value based on information of based on the light intensity distributions of the first region and the second region.

A method of manufacturing an optical element as another aspect of the present invention uses the wavefront measuring method.

An assembly adjustment apparatus of an optical system as another aspect of the present invention is configured to calculate an arrangement position or attitude of the optical element by the wavefront measuring method and perform assembly and adjustment of the optical system based on the arrangement position or the attitude.

Further features and aspects of the present invention will become apparent from the following description of exemplary embodiments with reference to the attached drawings.

### BRIEF DESCRIPTION OF THE DRAWINGS

FIG. 1 is a main part configuration diagram of a wavefront measuring apparatus in Embodiment 1.

FIG. 2 is a pattern diagram when a reference wavefront is incident on a Shack-Hartmann wavefront sensor (SHWFS).

FIG. 3 is a pattern diagram when a test wavefront is incident on the Shack-Hartmann wavefront sensor (SHWFS).

FIG. 4 is a pattern diagram when a test wavefront having large aberration is incident on the Shack-Hartmann wavefront sensor (SHWFS).

FIG. 5 is a diagram of an exemplary output signal from a detector array when the test wavefront having a large aberration is incident.

FIG. 6 is a block diagram of a signal processor in Embodiment 1.

FIG. 7 is an explanatory diagram of a barycenter detection region of a spot image in Embodiment 1.

FIG. 8 is a pattern diagram of inclination of a light beam incident on an encoding optical system (Shack-Hartmann wavefront sensor) in Embodiment 1.

FIG. 9 is a diagram illustrating an average incident angle error Δθ when barycenter detection is performed on each spot by two regions different from each other in Embodiment 1.

FIG. 10 is an explanatory diagram of a highly accurately wavefront recoverable region in Embodiment 1.

FIG. 11 is a block diagram of a signal processor in a modification of Embodiment 1.

FIG. 12 is a main part configuration diagram of a wavefront measuring apparatus in Embodiment 2.

FIG. 13 is a main part configuration diagram of a wavefront measuring apparatus in a modification of Embodiment 2.

FIG. 14 is a main part configuration diagram of a wavefront measuring apparatus in Embodiment 3.

FIG. 15 is a main part configuration diagram of a wavefront measuring apparatus in Embodiment 4.

FIG. 16 is a main part configuration diagram of a wavefront measuring apparatus in a modification of Embodiment 4.

### DESCRIPTION OF THE EMBODIMENTS

Exemplary embodiments of the present invention will be described below with reference to the accompanied drawings. In each of the drawings, the same elements will be denoted by the same reference numerals and the duplicate descriptions thereof will be omitted.

### Embodiment 1

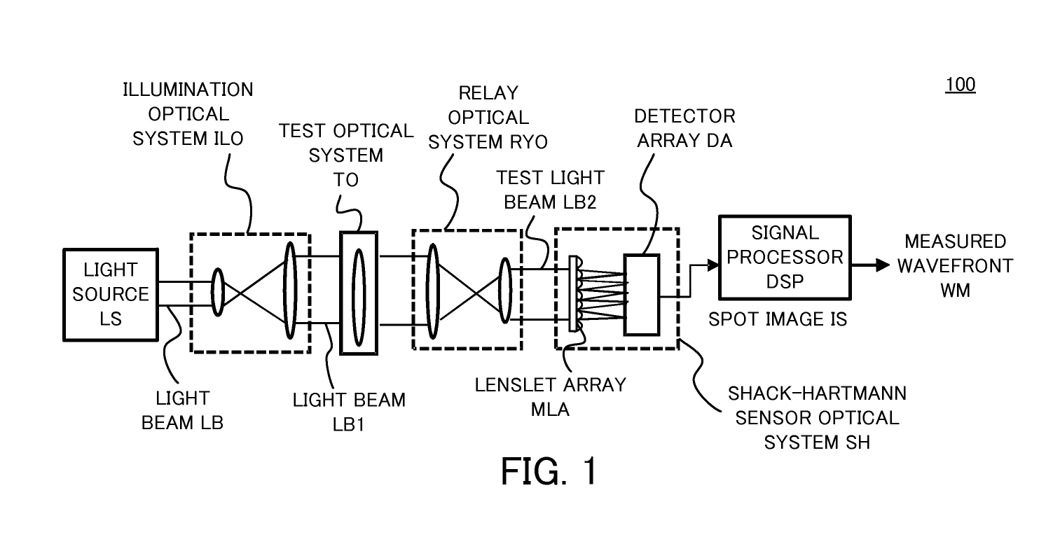

First, a wavefront measuring apparatus in Embodiment 1 of the present invention will be described. FIG. 1 is a main part configuration diagram of a wavefront measuring apparatus 100 in the present embodiment. The wavefront measuring apparatus 100 is configured to measure a transmitted wavefront or reflected wavefront of a test optical system (optical element).

In the wavefront measuring apparatus 100, a light beam LB from a light source LS is incident on an illumination optical system ILO. The illumination optical system ILO shapes the light beam LB into a desired light beam LB1. For example, the illumination optical system ILO is capable of extending a divergent light from an optical fiber or a pinhole into the light beam LB1 that covers a measurement region of the test optical system TO (an optical element to be measured). The illumination optical system ILO is also capable of adjusting the light quantity and the polarized state through an ND filter and a polarized filter. The light beam LB1 shaped by the illumination optical system ILO is incident on the test optical system TO. The light beam LB1 is transmitted through the test optical system TO and becomes a test light beam LB2.

A relay optical system RYO causes the test light beam LB2 transmitted through the test optical system TO to be incident on an encoding optical system so as to form a spatially modulated light intensity distribution. In the present embodiment, a Shack-Hartmann sensor optical system SH (Shack-Hartmann wavefront sensor) including a lenslet array MLA and a detector array DA (two-dimensional detector array) is used as the encoding optical system (measuring unit). However, the present embodiment is not limited thereto.

The light (test light beam LB2) incident on the lenslet array MLA forms a spot image IS depending on the inclination of a wavefront thereof on the detector array DA. The intensity distribution of the spot image formed on the detector array DA is provided with photoelectric conversion and AD (analog to digital) conversion by the detector array DA and then output as the spot image IS (intensity distribution data). The spot image IS (intensity distribution data) output from the detector array DA is provided with wavefront recovery processing by a signal processor DSP and then output as a measured wavefront WM.

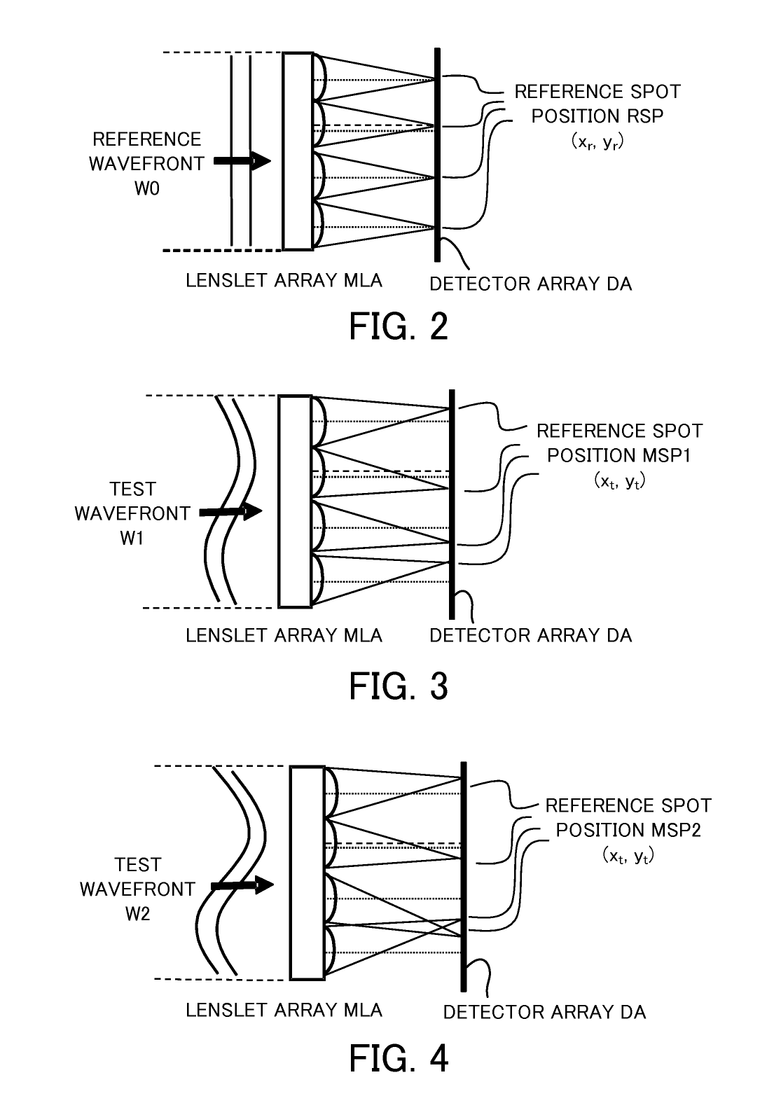

In a conventional Shack-Hartmann wavefront sensor (SHWFS), this relation between a wavefront and the spot image IS is modeled as a linear problem so as to reconstruct the wavefront from the spot image IS. A wavefront reconstruction algorithm of the conventional SHWFS will be described below. FIG. 2 is a pattern diagram when a reference wavefront is incident on the SHWFS. FIG. 3 is a pattern diagram when a test wavefront is incident on the SHWFS.

First, as illustrated in FIG. 2, a reference wavefront W0 is made incident on the lenslet array MLA while the test optical system TO is not provided, so as to previously determine reference spot positions RSP (xᵣ, yᵣ) formed by lenslets of the lenslet array MLA. The reference wavefront W0 may be a known plane wave or a dispersive spherical wave generated by a point light source.

Thereafter, as illustrated in FIG. 3, a test wavefront W1 to be measured is made incident on the lenslet array MLA so as to obtain measurement spot positions MSP1 (xₜ, yₜ). Each measurement spot position MSP1 can be calculated as a spot central position by algorithm such as barycenter detection for a spot formed by each lenslet. Then, the displacement of the spot position MSP1 by the test wavefront W1 with respect to the corresponding reference spot position RSP is obtained.

The lenslet is approximated to a thin lens, and the spot central position is defined to be the intersection point between a light ray passing through the center of the lenslet and a surface of the detector array DA. This configuration allows geometrical calculation of the inclination of the wavefront. Specifically, an average inclination of the wavefront incident on one of the lenslets constituting the lenslet array MLA can be calculated from the displacement of the spot central position and the distance between the lenslet array MLA and the detector array DA. A wavefront for one micro lens is calculated for all micro lenses, and the average inclination of the wavefront incident on the micro lens approximates the inclination of the wavefront at the center of the lenslet, whereby the wavefront inclination is calculated by integration. This processing allows reconstruction of the wavefront on the lenslet array MLA.

However, when this wavefront reconstruction algorithm of the conventional SHWFS is used, a large inclination of the test wavefront results in producing dense spots on the detector array DA, and those spots neighboring each other cause degradation of the accuracy of the spot center detection by the barycenter detection. Moreover, the elongation or deformation of the spots on the detector array DA degrades the accuracy of the spot center detection. An even larger inclination of the test wavefront causes overlaps of the spots, which potentially makes it impossible to reconstruct the wavefront. FIG. 4 is a pattern diagram when the test wavefront having a large aberration is incident on the SHWFS. As illustrated in FIG. 4, when a test wavefront W2 having a larger wavefront displacement than that of the test wavefront W1 is incident on the lenslet array MLA, a plurality of spot-forming light rays intersect each other at measurement spot positions MSP2 (xₜ, yₜ). This prevents identification of which spot is formed by which lenslet of the lenslet array MLA.

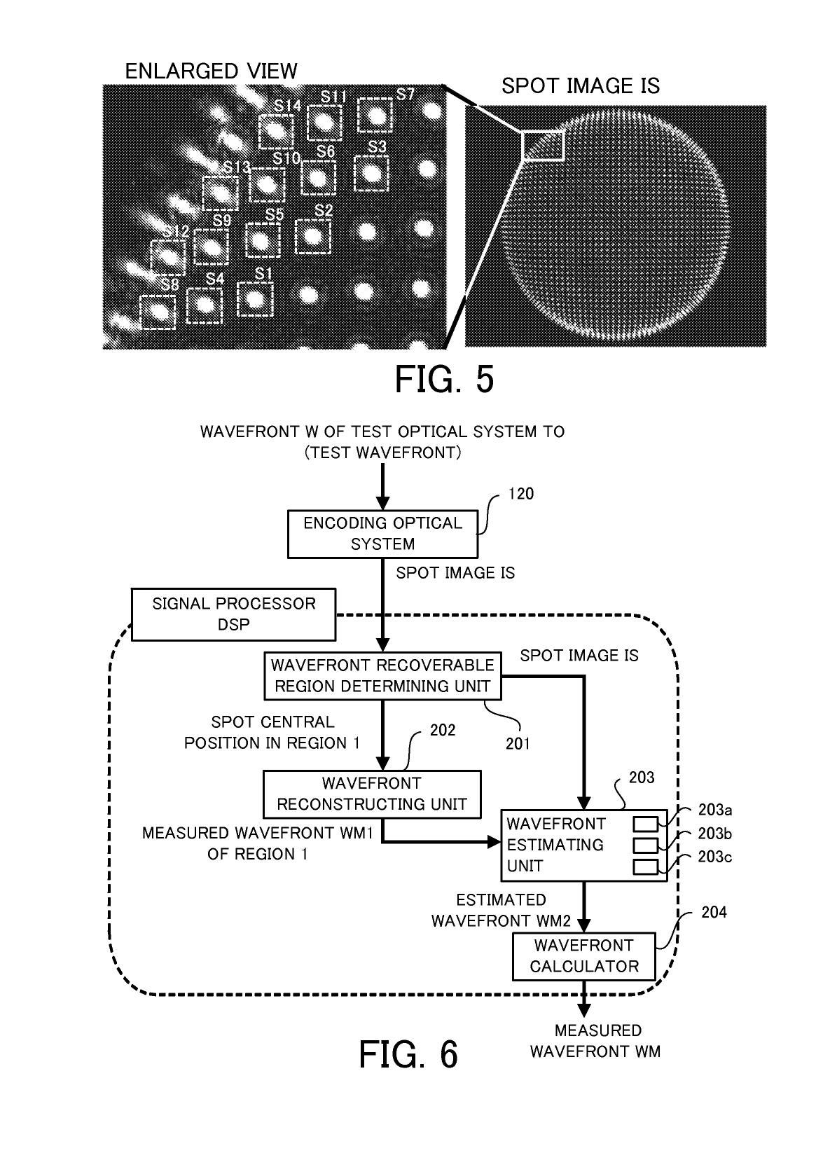

FIG. 5 is a diagram of an exemplary output signal from the detector array DA when the test wavefront having a large aberration is incident. In other words, FIG. 5 is an example of the spot image IS obtained when the wavefront transmitted through the test optical system TO is incident on the Shack-Hartmann sensor optical system SH. Since the test optical system TO has a large spherical aberration, spots overlap each other at a circumferential portion of the spot image IS. In this case, the wavefront reconstruction in this region (circumferential portion) is difficult with the wavefront reconstruction algorithm of the conventional SHWFS.

Referring to FIG. 6, a wavefront recovery algorithm performed at the signal processor DSP in the present embodiment when spots overlap each other will be described. FIG. 6 is a block diagram of the signal processor DSP in the wavefront measuring apparatus 100. As illustrated in FIG. 6, a wavefront W (test wavefront) of the test optical system TO is incident on an encoding optical system 120 (measuring unit). The encoding optical system 120 measures the light intensity distribution (spot image IS) based on each light beam transmitted through or reflected by the optical element. In other words, the encoding optical system 120 generates the light intensity distribution (spot image IS) including information of the test wavefront (transmitted wavefront or reflected wavefront of the optical element), and outputs the spot image IS to the signal processor DSP. In the present embodiment, a case of using the Shack-Hartmann sensor optical system SH as the encoding optical system 120 will be described.

A wavefront recoverable region determining unit 201 (region determining unit) of the signal processor DSP determines, based on the input spot image IS, a region where the wavefront is recoverable by the wavefront reconstruction algorithm of the SHWFS. In other words, the wavefront recoverable region determining unit 201 determines a first region (region 1) and a second region (region 2) based on a plurality of spot positions (included in regions L1 and L2) in the light intensity distribution (spot image IS). Specifically, for example, for a spot near the center of the spot image IS, a lenslet that forms the spot is determined. Subsequently, at neighboring spots toward the circumferential portion of the spot image IS, the barycenter detection is performed for each of the region L1 and the region L2. In this manner, the wavefront recoverable region determining unit 201 determines the first region (region 1) and the second region (region 2) based on a plurality of spot positions detected in detection regions (the regions L1 and L2) having sizes different from each other.

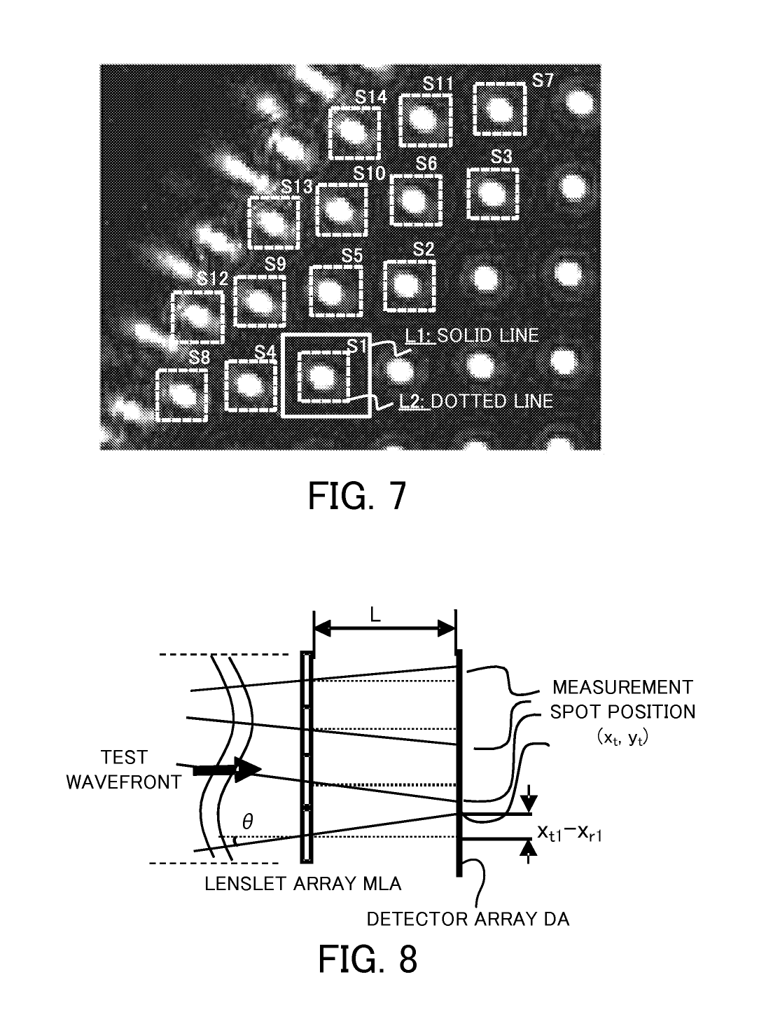

FIG. 7 is an explanatory diagram (enlarged view) of the barycenter detection region of the spot image IS and illustrates the region L1 and the region L2 at a spot S1 near the circumferential portion of the spot image IS. The region L2 is a region enclosed by a rectangle of a dotted line surrounding the spot S1. The region L1 is a region enclosed by a rectangle of a solid line larger than the region L2 and includes the region L2. As illustrated in FIG. 7, in an outermost circumferential portion of the spot image IS, the barycenter detection is performed for each of the region L1 and the region L2 at each of the spots S1 to S14.

Since the spot S1 is sufficiently distant from neighboring spots, the influence of the neighboring spots is small. Thus, the barycenter detection results (barycenter detection positions) in the respective regions L1 and L2 are substantially the same (have effectively no difference). On the other hand, outside the spot S14 for example, that is, in a region (the spots S8, S12, S13, and S14) distant from the center of the spot image IS, distances from neighboring spots are short or the neighboring spots overlap each other. This causes a difference between the barycenter detection results (barycenter detection positions) in the respective regions L1 and L2.

Influence on a wavefront measurement by the difference between the barycenter detection positions in the respective regions L1 and L2 will be considered below. The average inclination (wavefront slope) of a wavefront incident on one of the lenslets constituting the lenslet array MLA is calculated by the wavefront reconstruction algorithm of the SHWFS. The wavefront slope is calculated based on the displacements of the spot central positions with respect to the reference spot positions and the distance between the lenslet array MLA and the detector array DA.

FIG. 8 is a pattern diagram of the inclination of a light beam incident on the encoding optical system 120 (Shack-Hartmann sensor optical system SH). With the displacement (xₜ−xᵣ, yₜ−yᵣ) of the measurement spot position (xₜ, yₜ) with respect to the reference spot position (xᵣ, yᵣ) and the distance L between the lenslet array MLA and the detector array DA, a wavefront slope β is calculated as represented by Expression (1) below.

$$\begin{matrix}{( \begin{matrix}\frac{\partial w}{\partial x} \\ \frac{\partial w}{\partial y}\end{matrix} )}_{k} = {( \begin{matrix}{β}_{x} \\ {β}_{y}\end{matrix} )}_{k} \\ \approx \frac{1}{L} {( \begin{matrix}{x}_{t} - {x}_{r} \\ {y}_{t} - {y}_{r}\end{matrix} )}_{k}\end{matrix} \qquad ( 1 )$$

In Expression (1), w represents a wavefront shape, and k is an index number of each lenslet.

Then, when a difference is generated between a spot barycenter detection position (x_{t,L1}, y_{t,L1}) in the region L1 and a spot barycenter detection position (x_{t,L2}, y_{t,L2}) in the region L2, a wavefront slope error Δβ due to the difference is represented by Expression (2) below.

$$\begin{matrix}Δ β = \sqrt{Δ {β}_{x}^{2} + Δ {β}_{y}^{2}} \\ \approx \frac{1}{L} \sqrt{{( {x}_{t , L 1} - {x}_{t , L 2} )}^{2} + ( {y}_{t , L 1} - {y}_{t , L 2} )}\end{matrix} \qquad ( 2 )$$

As represented by Expression (3) below, the wavefront slope error Δβ can be converted into an average incident angle error Δθ.

Δθ=Tan⁻¹(Δβ) (3)

To reproducibly reconstruct the wavefront by the wavefront reconstruction algorithm of the SHWFS, the average incident angle error Δθ calculated from the barycenter detection positions in the respective regions L1 and L2 needs to be sufficiently small. For example, the focus component term Z4 in the Zernike polynomial will be considered here. When the coefficient of Z4 is represented by C4, the wavefront shape of the focus component term Z4 is represented by Expression (4) below.

C₄Z₄=C₄(2r²−1) (4)

In Expression (4), r is a normalization radius.

The relation between the average incident angle error Δθ and an error ΔC4 in the coefficient C4 (Zernike coefficient) is expressed by Expression (5) below.

$$\begin{matrix}Δ θ = {Tan}^{- 1} ( \frac{d }{d r} Δ {C}_{4} {Z}_{4} ( r ) ) \\ = {Tan}^{- 1} ( \frac{d }{d r} Δ {C}_{4} ( 2 {r}^{2} - 1 ) )\end{matrix} \qquad ( 5 )$$

In Expression (5), r is a wavefront analytical radius. In a typical wavefront measurement, the error ΔC4 (Zernike coefficient error) needs to be at least about 50 nm or less. Therefore, when the wavefront analytical radius r is 2 mm, the average incident angle error Δθ acceptable at the outermost of the analytical radius is about 0.1 milliradian or less.

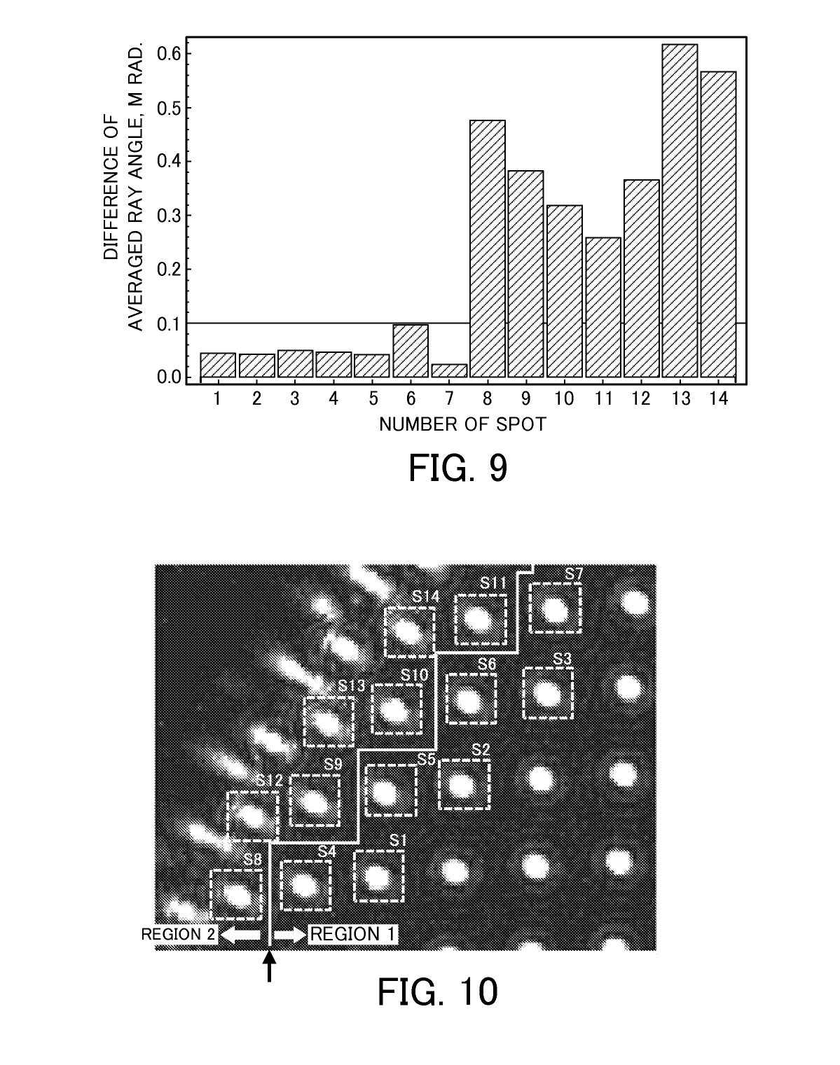

FIG. 9 is a graph of the average incident angle error Δθ when the barycenter detections in the detection regions (regions L1 and L2) having two sizes different from each other are performed for each spot (the spots S1 to S14). FIG. 9 illustrates a case where, in the spot image IS (intensity distribution data) of FIG. 7, the region L2 is set to be a region of 19×19 pixels, and the region L1 is set to be a region of 21×21 pixels. FIG. 9 illustrates calculation results of the average incident angle errors Δ in the lenslets of the lenslet array MLA that correspond to the respective spots S1 to S14.

The dimension (size) of one pixel of the detector array DA is 4.65 μm×4.65 μm. The distance L between the lenslet array MLA and the detector array DA is 3.7 mm. As illustrated in FIG. 9, a spot whose average incident angle error Δθ is not acceptable (that is, equal to or larger than 0.1 milliradian) is the spots S8 to S14. In the present embodiment, when the wavefront reconstruction algorithm of the SHWFS is used, as illustrated in FIG. 10, separation is possible between the first region (region 1) where a highly accurate wavefront reconstruction is possible and the second region (region 2) where an error in the wavefront reconstruction exceeds an acceptable value.

As described above, the wavefront measuring apparatus 100 (signal processor DSP) in the present embodiment performs the barycenter detection in the detection regions (regions L1 and L2) having two sizes different from each other and evaluates a wavefront error for each lenslet based on the difference between two detected barycenter positions. This allows the signal processor DSP to determine the wavefront recoverable region by the wavefront reconstruction algorithm of the SHWFS. That is, the signal processor DSP is capable of appropriately separating the first region (region 1) where a highly accurate wavefront recovery is possible and the second region (region 2) where a wavefront recovery error is large.

As described above, the signal processor DSP (wavefront recoverable region determining unit 201) illustrated in FIG. 6 determines the first region (region 1) where a highly accurate wavefront recovery is possible. Then, a wavefront reconstructing unit 202 (first signal processor) in the signal processor DSP calculates a first wavefront (measured wavefront WM1) by using a linear model based on information of the light intensity distribution (spot image IS) of the first region (region 1). In other words, the wavefront reconstructing unit 202 calculates the measured wavefront WM1 of the region 1 by the Shack-Hartmann wavefront recovery algorithm based on spot positions (the spot central positions) obtained by the barycenter detection or the like in the region 1. The wavefront reconstructing unit 202 preferably calculates the first wavefront by a geometric optical calculation.

Subsequently, a wavefront estimating unit 203 (second signal processor) calculates an estimated wavefront WM2 of the second region (region 2) based on the measured wavefront WM1 calculated by the wavefront reconstructing unit 202 and the spot image IS from the wavefront recoverable region determining unit 201. In other words, the wavefront estimating unit 203 repeats a light propagation calculation based on information (the spot image IS) of the light intensity distributions of the first region (region 1) and the second region (region 2) with the first wavefront (the measured wavefront WM1) as an initial value, and estimates a second wavefront (the estimated wavefront WM2). In the present embodiment, the estimated wavefront WM2 is calculated by an estimation method such as a maximum-likelihood method. The wavefront estimating unit 203 preferably estimates the estimated wavefront WM2 by an optimization calculation of wavefront parameters.

Then, a wavefront calculator 204 (third signal processor) joins (stitches) the measured wavefront WM1 (measured wavefront of the region 1; the first wavefront) and the estimated wavefront WM2 (estimated wavefront of the region 2; the second wavefront). This allows the wavefront calculator 204 to calculate the measured wavefront WM of all analytical regions including the regions 1 and 2, that is, the transmitted wavefront or reflected wavefront of the test optical system TO (optical element).

The processing by the wavefront estimating unit 203 will be described below. The wavefront estimating unit 203 estimates the wavefront W of the test optical system TO by solving a non-linear problem by numerical analysis. Simultaneously, the wavefront estimating unit 203 can estimate physical model parameters of a measuring optical system (the wavefront measuring apparatus 100). The physical model parameters of the measuring optical system include parameters that contribute generation of a final spot image distribution, such as the wavefront and intensity distribution of illumination light, the shape of the optical element, the arrangement of the optical element, lenslet array parameters, and detector characteristics. In addition to estimating the wavefront W of the test optical system TO, the wavefront estimating unit 203 can estimate physical model parameters of the test optical system TO that contribute generation of the spot image distribution, such as the shape of the optical element, the arrangement of the optical element, the refractive index and reflectance characteristics of the optical element.

The wavefront estimating unit 203 preferably includes a first processing unit 203a configured to perform the light propagation calculation based on the physical model parameters of the optical element (test optical system TO) and the wavefront measuring apparatus 100. The wavefront estimating unit 203 also includes a second processing unit 203b configured to calculate a cost function based on data from the Shack-Hartmann sensor optical system SH (measuring unit) and a result of the light propagation calculation. The wavefront estimating unit 203 further includes a third processing unit 203c configured to determine the physical model parameters with the cost function repeatedly calculated with different physical model parameters as a measure (index).

In the present embodiment, the physical model parameters can be estimated by an estimation method such as a maximum-likelihood method for example. In the present embodiment, the wavefront estimating unit 203 uses the measured wavefront WM1 of the region 1 as an initial value of the measured wavefront WM of the test optical system TO to be estimated. The wavefront estimating unit 203 uses the measured wavefront WM1 of the region 1 as the initial value to perform a forward propagation calculation involving the light propagation calculation with the physical model parameters of the measuring optical system, thereby obtaining the spot image IS as an output of the detector array DA by calculation. The forward propagation calculation may be performed by methods such as geometric optical light ray tracing, wave optics, and beamlet propagation calculation. The wavefront estimating unit 203 also calculates a likelihood based on a calculated spot image obtained in this manner and the spot image IS actually obtained by the optical system. A likelihood function that calculates the likelihood may be, for example, a function with various noise factors taken into consideration that is disclosed in Harrison H. Barrett, Christopher Dainty, and David Lara, “Maximum-likelihood methods in wavefront sensing: stochastic models and likelihood functions, J. Opt. Soc. Am. A. 24, 391-414 (2007).

The maximum-likelihood method repeats the forward propagation calculation (the light propagation calculation) and the calculation of the likelihood function with different measured wavefronts WM (estimated wavefronts WM2) and different physical model parameters. These calculations search for the measured wavefront WM (estimated wavefront WM2) and the physical model parameters that make the likelihood maximum. Then, the measured wavefront WM (estimated wavefront WM2) and the physical model parameters when it is determined that the likelihood has converged to a maximum value are set as estimated values of the measured wavefront WM (estimated wavefront WM2) and the physical model parameters. Such a search for the physical model parameters with which a maximum likelihood is reached is performed by a simulated annealing method or a downhill simplex (Nelder-Mead) method. However, the present embodiment is not limited thereto and may employ various optimizing methods such as a conjugate gradient method and the like.

The wavefront measuring apparatus 100 (wavefront calculator 204) in the present embodiment is capable of performing, by calculating the measured wavefront WM as a measurement result of the test wavefront W, a highly accurate wavefront measurement even when the test wavefront W is a large aberration wavefront having a large wavefront displacement and a plurality of spots overlap each other. Furthermore, the wavefront measuring apparatus 100 (wavefront estimating unit 203) in the present embodiment uses the previously highly accurately measured wavefront WM1 as the initial value of the measured wavefront WM (estimated wavefront WM2). This enables reduction in time required for estimation as compared to time required for estimation of the wavefront for all regions (the regions L1 and L2) and achieves a highly accurate convergence of the estimation. The spot image IS of the region 2 may be used as the spot image IS used in the estimation in place of data of all regions (the regions L1 and L2). This configuration enables reduction in time required for the forward propagation calculation by the wavefront estimating unit 203, thereby allowing an even faster wavefront measurement.

The wavefront measuring apparatus 100 in the present embodiment does not require a highly accurate optical element that is required in conventional measurement of a large aberration wavefront and that generates a reference wavefront for calibration. This allows reduction in cost of designing, measuring, and manufacturing such a highly accurate optical element. As a result, a short-time and low-cost evaluation can be made of the wavefront of an optical element or an optical unit that produces a wavefront having large aberrations. Based on this measured wavefront, performance evaluation and unit adjustment can be made for each element or each unit, thereby providing a low-cost high-performance wavefront measuring apparatus 100 (optical system). The present embodiment also provides an optical system that stores, as data, the measured wavefront of the optical system that is measured by the wavefront measuring apparatus 100 in the present embodiment, and that outputs image and data on which aberration correction is digitally performed by signal processing based on the measured wavefront. The aberration correction may be performed with an actual correction optical system. Since there is no need to precisely control aberrations of the optical system when designing and manufacturing the optical system, an even lower-cost optical system and an optical system including the optical system can be provided.

In the present embodiment, the region determining method by the wavefront recoverable region determining unit 201 is not limited to a method using the result of the barycenter detection of the region L1 and the region L2. For example, the region determining method may employ a condition that a main lobe does not overlap neighboring main lobes, that is, a distance d between neighboring spot positions is equal to or less than a predetermined value. In this manner, the wavefront recoverable region determining unit 201 may determine the first region (region 1) and the second region (region 2) based on the distance d between neighboring spot positions. Specifically, when λ is the wavelength of a light source, NA is the numerical aperture of a lenslet, w is the diameter of the lenslet, and f is the focal length of the lenslet, the distance d between neighboring spot positions is represented as Expression (6) below.

$$d \leq 1.22 \frac{λ}{NA} \approx 2.44 \frac{λ f}{w} \qquad ( 6 )$$

The wavefront recoverable region determining unit 201 may determine the first region (region 1) based on the condition expressed by Expression (6). For example, the values of λ=0.53 μm, w=150 μm, and f=6 mm, give d<52 μm. The values of λ=0.532 μm, w=150 μm, and f=12 mm, give d<104 μm. The signal processing can be simplified by determining, based on such a criterion, a region where measurement is possible by the wavefront reconstruction algorithm of the conventional SHWFS, thereby reducing time required for the measurement.

Alternatively, the wavefront recoverable region determining unit 201 may detect a spot position by the barycenter detection and employ, as a region determining condition, whether an incident angle of a light corresponding to the spot position (angle of a light ray incident on the encoding optical system 120) is within a predetermined angle. In this manner, the wavefront recoverable region determining unit 201 can determine the first region (region 1) and the second region (region 2) based on the angle of the light ray incident on the encoding optical system 120. For example, a condition can be set that the incident angle is equal to or less than an angle at which a sensor (the encoding optical system 120) suffers a significant degradation of incident angle characteristics, thereby obtaining a measurement result that does not depend a sensitivity error of the sensor in many cases.

Alternatively, the wavefront recoverable region determining unit 201 may use, as the region determining condition, a designed value (designed data) of the wavefront measuring apparatus 100 including the test optical system TO. In this case, a region where a plurality of spots overlap or the accuracy of the wavefront recovery is degraded can be predicted by the light ray tracing and the like. The wavefront recoverable region determining unit 201 previously stores such information to perform the region determination. This allows reduction in time required for measurement.

In the present embodiment, the encoding optical system 120 for forming the spot image IS on the detector array DA is described as a configuration including the lenslet array MLA, but is not limited thereto. The encoding optical system 120 may be, for example, an aperture plate including a plurality of openings (apertures), a one-dimensional lattice, or a two-dimensional lattice. When the aperture plate is used, the wavefront reconstructing unit 202 can employ a wavefront recovery algorithm of a publicly known Hartmann screen. When the one-dimensional lattice or the two-dimensional lattice is used, the wavefront reconstructing unit 202 can employ a Ronchi test method and an FFT method to perform the wavefront reconstruction of the region 1. These method are based on a linear model of a relation between observation data output from the detector array DA and a wavefront, and the wavefront reconstructing unit 202 can also employ similar methods other than these methods.

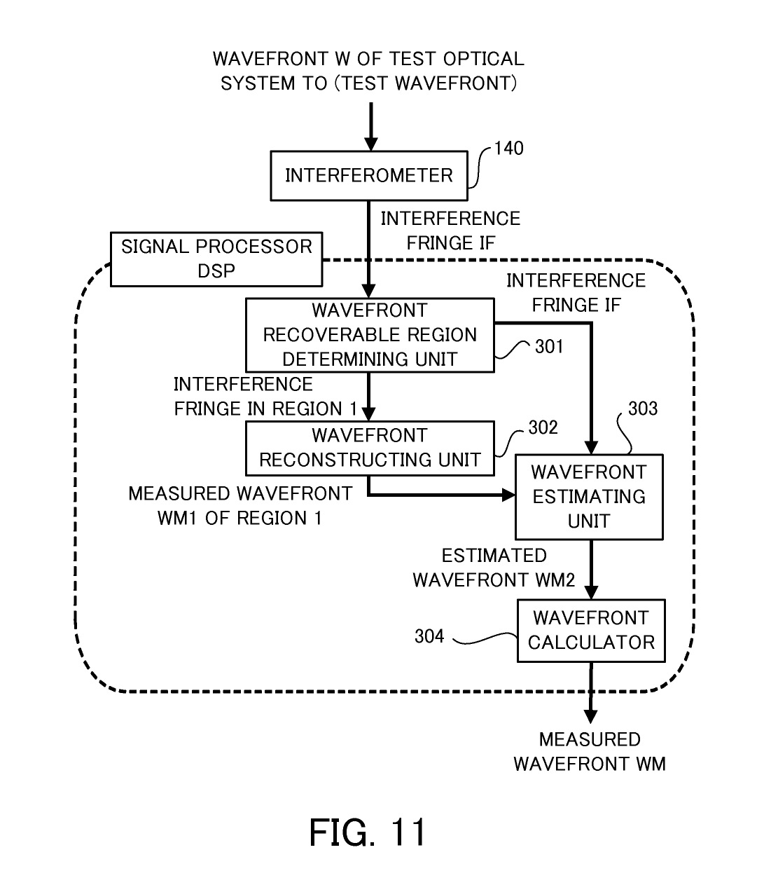

Furthermore, in the wavefront measuring apparatus 100 in the present embodiment, an interferometer may be used as the encoding optical system. FIG. 11 is a block diagram of the signal processor DSP in a modification of the present embodiment, and illustrates the configuration of the signal processor DSP when an interferometer 140 is used as the encoding optical system.

An interference fringe IF obtained by the interferometer 140 is output to a wavefront recoverable region determining unit 301. The wavefront recoverable region determining unit 301 determines the region 1 where the wavefront reconstruction is possible by normal interference fringe analysis. Conditions of determining the region 1 include, for example, a condition that a pitch of the interference fringe IF is equal to or larger than 3 pixels of the detector array DA. The interference fringe analysis may be performed by a geometric optical method or an FFT method.

A wavefront reconstructing unit 302 (first signal processor) calculates the measured wavefront WM1 of the region 1 by performing the interference fringe analysis (geometric optical calculation) based on the interference fringe in the region 1. Subsequently, a wavefront estimating unit 303 (second signal processor) calculates the estimated wavefront WM2 of the second region (region 2) based on the measured wavefront WM1 of the first region (region 1) calculated by the wavefront reconstructing unit 302 and the interference fringe IF from the wavefront recoverable region determining unit 301. Then, a wavefront calculator 304 (third signal processor) joins (stitches) the measured wavefront WM1 (measured wavefront of the region 1) and the estimated wavefront WM2 (estimated wavefront of the region 2), thereby calculating the measured wavefront WM of all analytical regions including the region 1 and the region 2. The dynamic range of the wavefront measurement can be expanded with such a wavefront measuring apparatus.

### Embodiment 2

Next, a wavefront measuring apparatus in Embodiment 2 of the present invention will be described. The wavefront measuring apparatus 100 in Embodiment 1 includes the relay optical system RYO that images the test light beam LB2 (a wavefront on the pupil of the test optical system TO) onto the lenslet array MLA. In contrast, a wavefront measuring apparatus 100a in the present embodiment includes a simpler optical system in place of the relay optical system RYO so as to be capable of measuring a larger wavefront.

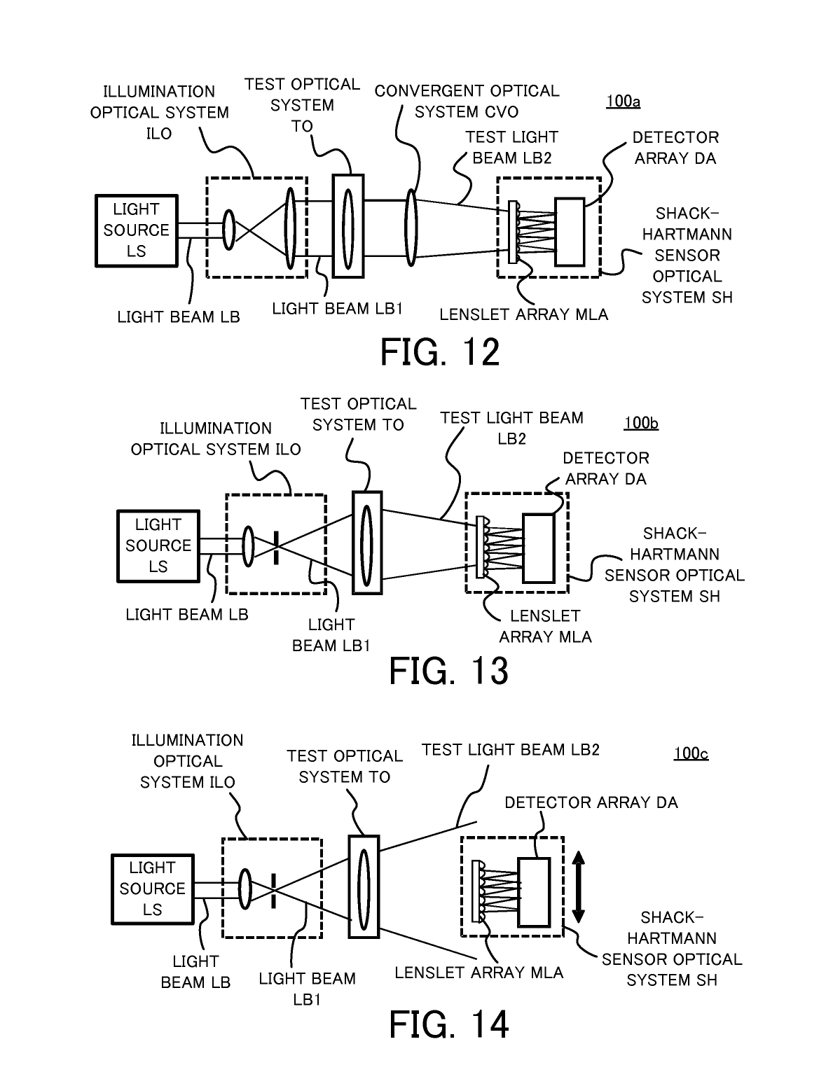

FIG. 12 is a main part configuration diagram of the wavefront measuring apparatus 100a in the present embodiment. The wavefront measuring apparatus 100a includes a convergent optical system CVO (scaling optical system) in place of the relay optical system RYO. The convergent optical system CVO scales the diameter of a light beam so that the test light beam LB2 is incident within the lenslet array MLA. The present embodiment uses the convergent optical system CVO having a positive power that scales down to such a size that the test light beam LB2 is incident within the lenslet array MLA, but is not limited thereto. Any optical system that optionally scales a transmitted light beam from the test optical system TO may be used. In this case, the shape of a wavefront on the pupil (exit pupil) of the test optical system TO can be obtained by measuring the wavefront W on the lenslet array MLA, and once the measured wavefront WM is obtained, performing the light ray tracing or a back propagation to obtain the wavefront on the pupil (exit pupil).

When the back propagation is performed with a non-uniform intensity distribution of the test light beam LB2, the intensity distribution of the test light beam LB2 on the lenslet array MLA based on the spot image IS (intensity distribution data) obtained from the Shack-Hartmann sensor optical system SH is used in addition to the measured wavefront WM. This can improve the accuracy of the back propagation calculation. In the present embodiment, the intensity distribution of the test light beam LB2 may be separately measured by an image sensor (not illustrated), and this measurement result may be applied to the back propagation calculation.

FIG. 13 is a main part configuration diagram of a wavefront measuring apparatus 100b in another modification of the present embodiment. As illustrated in FIG. 13, the transmitted wavefront from the test optical system TO may be made directly incident on the lenslet array MLA as the test light beam LB2 to measure the test wavefront W. Such a configuration can reduce measurement inaccuracy due to the relay optical system RYO and reduce the cost of the optical system of the wavefront measuring apparatus (measuring system). Thus, a low-cost wavefront measuring apparatus having an even higher accuracy can be achieved.

### Embodiment 3

Next, a wavefront measuring apparatus in Embodiment 3 of the present invention will be described. The wavefront measuring apparatuses 100, 100a, and 100b in Embodiments 1 and 2 are designed to make the size of the test light beam LB2 equal to or smaller than the sizes of the lenslet array MLA and the detector array DA. In contrast, in the wavefront measuring apparatus in the present embodiment, the test light beam LB2 may be larger than the size of the lenslet array MLA due to divergent light.

FIG. 14 is a main part configuration diagram of a wavefront measuring apparatus 100c in the present embodiment. The wavefront measuring apparatus 100c causes the lenslet array MLA and the detector array DA (Shack-Hartmann sensor optical system SH) to traverse relative to the test light beam LB2, divides the whole cross section of the test light beam LB2 into a plurality of regions, and acquires the spot image IS. In other words, in the wavefront measuring apparatus 100c, the Shack-Hartmann sensor optical system SH (measuring unit) measures the light intensity distribution (spot image IS) by scanning a light beam transmitted through or reflected by the optical element (test optical system TO).

Then, the measuring unit can join (stitches) a plurality of spot images IS of the divided regions and measure the wavefront of the whole cross section of the test light beam LB2. Alternatively, the measuring unit may calculate the slope angles and wavefronts of the regions and join (stitch) them for a region corresponding to the whole cross section of the test light beam LB2. Alternatively, the spot images IS acquired for the respective divided regions may be separated into spot images to which the wavefront reconstruction algorithm of the conventional SHWFS is applicable and spot images to which the wavefront estimation is applied. In this case, whereas a wavefront reconstructed from the spot images to which the wavefront reconstruction algorithm is applied is used as an initial value, data of the remaining spot images to which the wavefront estimation is applied is used to estimate the whole wavefront.

Such configuration enables the wavefront measurement, with the lenslet array MLA and the detector array DA having finite sizes, of the test optical system having a large effective diameter or the test optical system having a negative power. Thus, a low-cost wavefront measuring apparatus (measuring system) can be achieved.

### Embodiment 4

Next, a wavefront measuring apparatus in Embodiment 4 of the present invention will be described. The wavefront measuring apparatuses 100 to 100c in Embodiments 1 to 3 is configured to measure, by a single path, the wavefront transmitted through the test optical system TO. In contrast, the wavefront measuring apparatus in the present embodiment includes a double-path optical system.

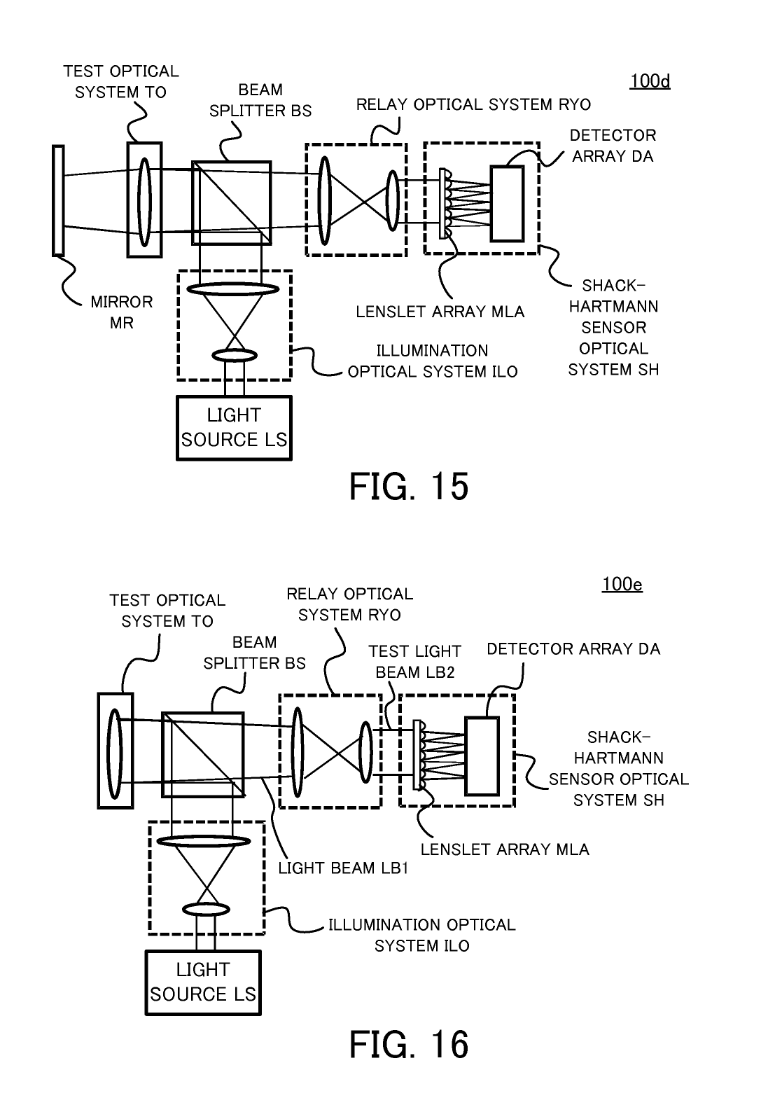

FIG. 15 is a main part configuration diagram of a wavefront measuring apparatus 100d in the present embodiment. The wavefront measuring apparatus 100d includes a beam splitter BS and is configured to measure the transmitted wavefront of the test optical system TO through the double-path optical system. With this configuration, the total length of the measuring optical system can be designed short, thereby reducing the size of the apparatus. However, an optical path on which light emitted from the light source LS is transmitted through the test optical system TO typically differs from an optical path on which the light is reflected by a plane or a spherical mirror (mirror MR) and transmitted through the test optical system TO. This difference between the optical paths causes what is called a retrace error. The configuration of the present embodiment allows calculation of the retrace error as calibration data, which leads to an improved measurement accuracy of the compact double-path optical system.

FIG. 16 is a main part configuration diagram of a wavefront measuring apparatus 100e in a modification of the present embodiment. As illustrated in FIG. 16, the wavefront measuring apparatus 100e includes the test optical system TO constituted by a reflective optical system. In this configuration, a measured wavefront can be obtained by calculation with the shape of a reflecting surface of the test optical system TO taken into account.

Each of the embodiments provides a low-cost wavefront measuring apparatus having a wide dynamic range. Measurement of a unit optical system or an optical element each included in an optical system such as a camera lens or a video lens is difficult by conventional methods because a transmitted wavefront largely deviates from a reference spherical surface in some cases when the unit optical system or the optical element is measured alone. Application of the configuration in each of the embodiments enables a highly accurate low-cost measurement of the transmitted wavefront and surface shape of such a unit optical system or an optical element. Consequently, the performance of the unit optical system or the optical element can be ensured alone, which contributes to achieving a low-cost high-performance imaging optical system.

In each of the embodiments, parameters used in assembly and adjustment of an optical unit can be calculated by measuring physical parameters including the shape of a wavefront. For example, the optimum arrangement position and attitude of an optical element that minimize aberration of the whole optical system can be calculated from the shape of the wavefront, the shape of a surface, and a refractive index distribution that are measured. The assembly and adjustment of the optical system based on the optimum arrangement position and attitude of the optical element enables provision of the optical system (an assembly adjustment apparatus of the optical system) whose optical performance is ensured.

As described above, each of the embodiments provides highly accurate and low-cost wavefront measuring apparatus, wavefront measuring method, method of manufacturing the optical element, and assembly adjustment apparatus of an optical system that are capable of performing wavefront measurement of an optical element having a large wavefront aberration. Consequently, developing cost and manufacturing cost of the optical element and an optical unit can be reduced, thereby allowing provision of a high-performance and low-cost optical system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-188814, filed on Sep. 11, 2013, which is hereby incorporated by reference herein in its entirety.

1. A wavefront measuring apparatus configured to measure a transmitted wavefront or reflected wavefront of an optical element, the wavefront measuring apparatus comprising:
a measuring unit configured to measure a light intensity distribution based on a light beam transmitted through or reflected by the optical element;
a region determining unit configured to determine a first region and a second region based on a plurality of spot positions in the light intensity distribution;
a first signal processor configured to calculate a first wavefront by using a linear model based on information of the light intensity distribution of the first region; and
a second signal processor configured to estimate a second wavefront by repeating a light propagation calculation with the first wavefront as an initial value based on information of the light intensity distributions of the first region and the second region.

2. The wavefront measuring apparatus according to claim 1, further comprising a third signal processor configured to stitch the first wavefront and the second wavefront to calculate the transmitted wavefront or the reflected wavefront of the optical element.

3. The wavefront measuring apparatus according to claim 1, wherein the second signal processor is configured to estimate the second wavefront by optimization calculation of a wavefront parameter.

4. The wavefront measuring apparatus according to claim 1, wherein:
the first signal processor is configured to calculate the first wavefront by geometric optical calculation, and
the second signal processor includes:
a first processing unit configured to perform the light propagation calculation based on physical model parameters of the optical element and the wavefront measuring apparatus,
a second processing unit configured to calculate a cost function based on data from the measuring unit and a result of the light propagation calculation, and
a third processing unit configured to determine the physical model parameters with the cost function repeatedly calculated with different physical model parameters as an index.

5. The wavefront measuring apparatus according to claim 1, wherein the measuring unit includes a lenslet array and a detector array.

6. The wavefront measuring apparatus according to claim 1, wherein the measuring unit includes an aperture plate including a plurality of apertures and a detector array.

7. The wavefront measuring apparatus according to claim 1, wherein the measuring unit includes a one-dimensional lattice or a two-dimensional lattice, and a detector array.

8. The wavefront measuring apparatus according to claim 1, wherein the measuring unit is a Shack-Hartmann wavefront sensor.

9. The wavefront measuring apparatus according to claim 1, wherein the measuring unit is an interferometer.

10. The wavefront measuring apparatus according to claim 1, wherein the region determining unit is configured to determine the first region and the second region based on the spot positions detected in detection regions having a plurality of sizes different from each other.

11. The wavefront measuring apparatus according to claim 1, wherein the region determining unit is configured to determine the first region and the second region based on a distance between neighboring spot positions.

12. The wavefront measuring apparatus according to claim 1, wherein the region determining unit is configured to determine the first region and the second region based on an angle of a light ray incident on the measuring unit.

13. The wavefront measuring apparatus according to claim 1, wherein the region determining unit is configured to determine the first region and the second region based on a designed value of the wavefront measuring apparatus.

14. The wavefront measuring apparatus according to claim 1, wherein the measuring unit is configured to measure the light intensity distribution by scanning the light beam transmitted through or reflected by the optical element.

15. The wavefront measuring apparatus according to claim 1, wherein the measuring unit is configured to measure a wavefront on an exit pupil of the optical element.

16. A wavefront measuring method that measures a transmitted wavefront or reflected wavefront of an optical element, the method comprising the steps of:
measuring a light intensity distribution based on a light beam transmitted through or reflected by the optical element;
determining a first region and a second region based on a plurality of spot positions in the light intensity distribution;
calculating a first wavefront by using a linear model based on information of the light intensity distribution of the first region; and
estimating a second wavefront by repeating a light propagation calculation with the first wavefront as an initial value based on information of the light intensity distributions of the first region and the second region.

17. The wavefront measuring method according to claim 16, further comprising the step of stitching the first wavefront and the second wavefront to calculate the transmitted wavefront or the reflected wavefront of the optical element.

18. The wavefront measuring method according to claim 16, wherein the spot positions are detected in detection regions having a plurality of sizes different from each other.

19. A method of manufacturing an optical element by using a wavefront measuring method that measures a transmitted wavefront or reflected wavefront of an optical element, the method comprising the steps of:
measuring a light intensity distribution based on a light beam transmitted through or reflected by the optical element;
determining a first region and a second region based on a plurality of spot positions in the light intensity distribution;
calculating a first wavefront by using a linear model based on information of the light intensity distribution of the first region; and
estimating a second wavefront by repeating a light propagation calculation with the first wavefront as an initial value based on information of the light intensity distributions of the first region and the second region.

20. An assembly adjustment apparatus of an optical system, wherein the apparatus is configured to:
calculate an arrangement position or attitude of the optical element by using a wavefront measuring method that measures a transmitted wavefront or reflected wavefront of an optical element, the method comprising the steps of:
measuring a light intensity distribution based on a light beam transmitted through or reflected by the optical element;
determining a first region and a second region based on a plurality of spot positions in the light intensity distribution;
calculating a first wavefront by using a linear model based on information of the light intensity distribution of the first region; and
estimating a second wavefront by repeating a light propagation calculation with the first wavefront as an initial value based on information of the light intensity distributions of the first region and the second region, and
perform assembly and adjustment of the optical system based on the arrangement position or the attitude.
